(19) United States
(12) Patent Application Publication
(10) Pub. No.: US 2024/0426519 A1
(43) Pub. Date: Dec. 26, 2024

(54) SOLAR POWER SYSTEM

(71) Applicant: PLANET A ENERGY, INC., Pasadena, CA (US)

(72) Inventors: Michael TURK, Porter Ranch, CA (US); Braden Eric HINES, Pasadena, CA (US); Richard Lee JOHNSON, Suffolk, VA (US)

(21) Appl. No.: 18/766,638

(22) Filed: Jul. 8, 2024

Related U.S. Application Data
(63) Continuation-in-part of application No. 18/429,235, filed on Jan. 31, 2024, now abandoned.
(60) Provisional application No. 63/482,795, filed on Feb. 1, 2023.

(51) Int. Cl. F24S 20/20; F24S 20/00; F24S 23/00; F24S 23/70; F24S 23/71; F24S 30/45; F24S 50/20; F24S 80/00; F24S 80/30

(52) U.S. Cl. CPC F24S 20/20; F24S 23/12; F24S 23/71; F24S 30/45; F24S 80/30; F24S 2020/11; F24S 2020/186; F24S 2020/23; F24S 2023/876; F24S 50/20; F24S 2080/05

(57) ABSTRACT

A system for collecting and storing solar energy as heat. In some embodiments, the system includes heat transfer passages for collecting and transferring heat, as well as ways of arranging passages to minimize thermal losses and redistribute heat. In some embodiments, the system includes an all-reflective solar collector with a largely clear aperture, using multiple light transfer conduits that rotate with the collector.

### CROSS-REFERENCE TO RELATED APPLICATION(S)/PRIORITY CLAIM

The present application is a continuation-in-part of U.S. patent application Ser. No. 18/429,235, filed Jan. 31, 2024, entitled “SOLAR POWER SYSTEM AND MODULAR SOLAR THERMAL SYSTEM WITH SEASONAL ENERGY STORAGE”, which claims priority to and the benefit of U.S. Provisional Application No. 63/482,795, filed Feb. 1, 2023, entitled “SOLAR POWER SYSTEM AND MODULAR SOLAR THERMAL SYSTEM WITH SEASONAL ENERGY STORAGE”, the entire contents of both of which are incorporated herein by reference.

The present application is related to U.S. Pat. No. 10,203,134, issued Feb. 12, 2019, entitled “SOLID STATE SOLAR THERMAL ENERGY COLLECTOR”, and to U.S. Pat. No. 11,440,814, issued Sep. 13, 2022, entitled “SOLID STATE SOLAR THERMAL ENERGY COLLECTOR”, the entire contents of both of which are incorporated herein by reference.

### FIELD

The invention relates generally to the field of solar energy, specifically solar thermal energy. The solar heat that is collected may either be used directly as heat or to generate electricity. The invention also relates generally to the field of solar energy storage.

### BACKGROUND

In one form of a solar thermal energy system, solar collectors and receivers are arranged into so-called concentrating solar power (CSP) systems. CSP systems traditionally involve large arrays of mirrors that reflect the sun to a focal point or line, where the intense concentrated sunlight is used to heat fluid.

Applicants' previous U.S. Pat. No. 10,203,134 (hereafter referred to as '134) and 11,440,814 (hereafter referred to as '814) describe a novel approach to high-concentration CSP that does not require a tall tower, using many small collectors to collect solar energy as heat, and an arrangement of passages for storing the collected thermal energy in a stationary bed of thermal storage material and transferring it to a location where it can do useful work.

Solar trackers may be used to track the sun, e.g., in solar power systems. One of the challenges with tracking for concentrated solar systems is that, while it would be ideal to place a camera or other tracking sensor at the focus of the beam, the focus of a concentrating solar collector is generally not a viable place to put a sensor, since it is intentionally subjected to intense solar radiation.

### SUMMARY

According to an embodiment of the present invention, there is provided a system, including: a concentrating solar thermal power collection and storage system, the concentrating solar thermal power collection and storage system including: an insulated barrier surrounding an insulated region; a stationary thermal energy storage material within the insulated region; and a passage for a heat transfer fluid, the passage including an inlet end and an outlet end and passing through: a peripheral point, at a first distance from an exterior surface of the system, and a central point, at a second distance from the exterior surface of the system, the second distance being greater than the first distance, and a distance, along the passage, from the central point to the inlet end being greater than a distance, along the passage, from the central point to the outlet end.

In some embodiments, a distance, along the passage, from the peripheral point to the inlet end is less than a distance, along the passage, from the peripheral point to the outlet end.

In some embodiments, a portion of the passage is embedded within the stationary thermal energy storage material.

In some embodiments, the system further includes: a concentrating solar energy collector; and a light transfer conduit for transferring received energy through the insulated barrier from outside the insulated region to inside the insulated region.

In some embodiments, the light transfer conduit extends into the passage.

In some embodiments, the system includes: a partition separating a first portion of the passage from a second portion of the passage; and a port in the partition, the port, when opened, permitting heat transfer fluid to flow through the port from the first portion of the passage into the second portion of the passage.

According to an embodiment of the present invention, there is provided a method for operating a system, the method including: causing, during a first time interval, heat transfer fluid to flow into the inlet end of the passage, and causing, during a second time interval, heat transfer fluid to flow into the outlet end of the passage.

According to an embodiment of the present invention, there is provided a system, including: a concentrating solar energy collector, the concentrating solar energy collector including: a first reflector; a second reflector; a first light transfer conduit; and a second light transfer conduit, the first reflector being configured to focus received solar radiation onto an entrance to the first light transfer conduit, a reflected ray path from the first reflector extending substantially horizontally to the entrance to the first light transfer conduit.

In some embodiments: the second reflector is configured to focus received solar radiation onto an entrance to the second light transfer conduit, a reflected ray path from the second reflector extending substantially horizontally to the entrance to the second light transfer conduit.

In some embodiments, the first reflector is configured to rotate about a first elevation axis, the first elevation axis passing through the entrance to the first light transfer conduit.

In some embodiments, the system further includes: a third light transfer conduit; a third reflector, configured to focus received solar radiation onto an entrance to the third light transfer conduit; a fourth light transfer conduit; and a fourth reflector, configured to focus received solar radiation onto an entrance to the fourth light transfer conduit, wherein: a reflected ray path from the third reflector extends substantially horizontally to the entrance to the third light transfer conduit, and a reflected ray path from the fourth reflector extends substantially horizontally to the entrance to the fourth light transfer conduit.

In some embodiments, the third reflector is configured to rotate about a second elevation axis, the second elevation axis passing through the entrance to the third light transfer conduit.

In some embodiments: the fourth reflector is configured to rotate about the second elevation axis, and the second elevation axis passes through the entrance to the fourth light transfer conduit.

In some embodiments, the third reflector is connected to the first reflector by a link, the link being one of four links forming a parallelogram four-bar linkage.

In some embodiments, the entrance to the first light transfer conduit is an entrance to a non-imaging concentrator optic.

In some embodiments: the first light transfer conduit includes a curved portion, and the second light transfer conduit includes a curved portion.

In some embodiments: the first light transfer conduit conducts light to a fixed final shared light transfer conduit, and the second light transfer conduit conducts light to the fixed final shared light transfer conduit.

In some embodiments, the concentrating solar energy collector is configured: to articulate in azimuth through a range of azimuth angles spanning at least 90 degrees, to articulate in elevation through a first range of elevation angles spanning at least 60 degrees, to fit within a fixed vertical cylindrical volume, for all azimuth angles in the range of azimuth angles and all elevation angles in the range of elevation angles, the fixed cylindrical volume having a diameter less than 1.5 times a diameter of the reflective surface as seen from the direction of the received solar radiation.

In some embodiments: the first reflector is an off-axis parabolic reflector focusing received solar radiation generally toward the second reflector, and the second reflector is an off-axis parabolic reflector focusing received solar radiation generally toward the first reflector.

### BRIEF DESCRIPTION OF THE DRAWINGS

FIG. 1 shows an exemplary solar power system with seasonal energy storage that includes an embodiment of the present invention, according to an embodiment of the present disclosure.

FIG. 2 is a view of tunnel segments, showing the tunnel segments arranged as passages in a maze, according to an embodiment of the present disclosure.

FIG. 3 shows a 3D perspective view of a solar power system including an array of tunnel segments arranged as passages in a maze, according to an embodiment of the present disclosure.

FIG. 4 shows a tunnel segment with a heat transfer conduit embedded within the thermal storage medium, according to an embodiment of the present disclosure.

FIG. 5 shows the system of FIG. 2 flowing heat transfer fluid in the backwards direction, according to an embodiment of the present disclosure.

FIG. 6 shows a system like FIG. 2, including a port that can be opened between passages to permit heat flow, according to an embodiment of the present disclosure.

FIG. 7 shows an embodiment of an all-reflective collector, according to an embodiment of the present disclosure.

FIG. 8 is another view of the FIG. 7 embodiment, showing the entire light transfer conduit, according to an embodiment of the present disclosure.

FIG. 9 shows another embodiment of an all-reflective collector, highlighting the drive and support mechanical elements of the collector, according to an embodiment of the present disclosure.

FIG. 10 is an overhead view of the collector of FIG. 9, according to an embodiment of the present disclosure.

FIG. 11 shows the elevation drive components of the collector of FIG. 9, according to an embodiment of the present disclosure.

FIG. 12 illustrates how the collector focuses light, according to an embodiment of the present disclosure.

FIG. 13 is a detailed view of a tracking sensor, according to an embodiment of the present disclosure.

FIG. 14 shows an embodiment of an all-reflective collector comprising four individual reflector quadrants, according to an embodiment of the present disclosure.

FIG. 15 is an overhead view of the collector of FIG. 14, according to an embodiment of the present disclosure.

FIG. 16 illustrates how the collector of FIG. 14 focuses light, according to an embodiment of the present disclosure.

FIG. 17 shows the collector of FIG. 14 with the azimuth yoke structure removed, to reveal the light transfer conduits, according to an embodiment of the present disclosure.

FIG. 18 is a detailed view of the focus of one of the reflector quadrants, according to an embodiment of the present disclosure.

FIG. 19 illustrates the elevation axis of the embodiment of FIG. 14, according to an embodiment of the present disclosure.

FIG. 20 illustrates the undesirable result if one were to rigidly connect the upper and lower quadrant reflectors.

FIG. 21 illustrates the pivot axis of the lower quadrant reflectors, according to an embodiment of the present disclosure.

FIG. 22 illustrates the parallelogram linkage that helps the reflector quadrants to stay on focus as the collector rotates in elevation, according to an embodiment of the present disclosure.

FIG. 23 illustrates how the parallelogram linkage of FIG. 22 works, according to an embodiment of the present disclosure.

FIG. 24 shows the reflector support struts and the tracking sensor, according to an embodiment of the present disclosure.

FIG. 25 illustrates another form of a system comprising multiple containers arranged to form passages, according to an embodiment of the present disclosure.

FIG. 26 illustrates an example of a solar energy storage and collection system that may benefit from embodiments of the present disclosure.

### DETAILED DESCRIPTION

Some embodiments of the present invention relate to apparatus and methods related to solar concentrating systems and concentrating solar power. However, the apparatus and methods are generally applicable to any system in which it is desirable to manage solar thermal energy collection and delivery.

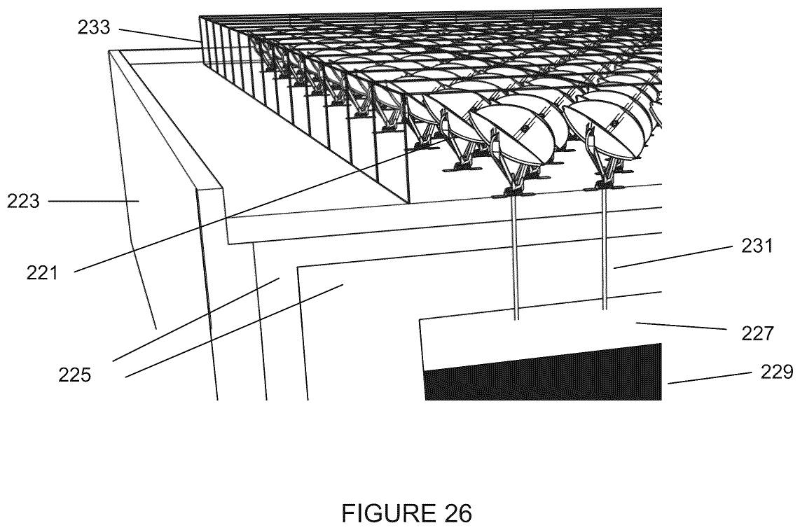

Some embodiments of the present invention may generally have application in solar energy systems with features such as those shown in the system of FIG. 26, which is a cutaway view of a portion of a solar energy collection and storage system.

In FIG. 26, an array of solar energy collectors 221 is provided on top of a thermal energy storage container 223. The container includes insulation layers 225 and delivers concentrated solar energy into a cavity 227. A thermal energy storage medium 229 absorbs the concentrated solar energy and preserves it as heat. A key feature of the system shown is that each collector is provided with a solid glass light transfer conduit 231, which conducts concentrated solar energy from the collector through the insulation layer into the interior of the storage container 223. An aspect of the system that differs compared to some solar thermal systems is that the thermal energy storge medium 229 is stationary.

An important aspect of the system of FIG. 26 is how the stored energy is extracted. The FIG. 26 system can extract heat by flowing air or another heat transfer fluid through the cavity region 227, drawing heat from the stationary thermal storage medium 229. By structuring the cavity into multiple conduits, a desired amount of heat flow at a desired rate may be achieved.

The present disclosure describes apparatus, methods, and approaches for flowing a heat transfer fluid through the system.

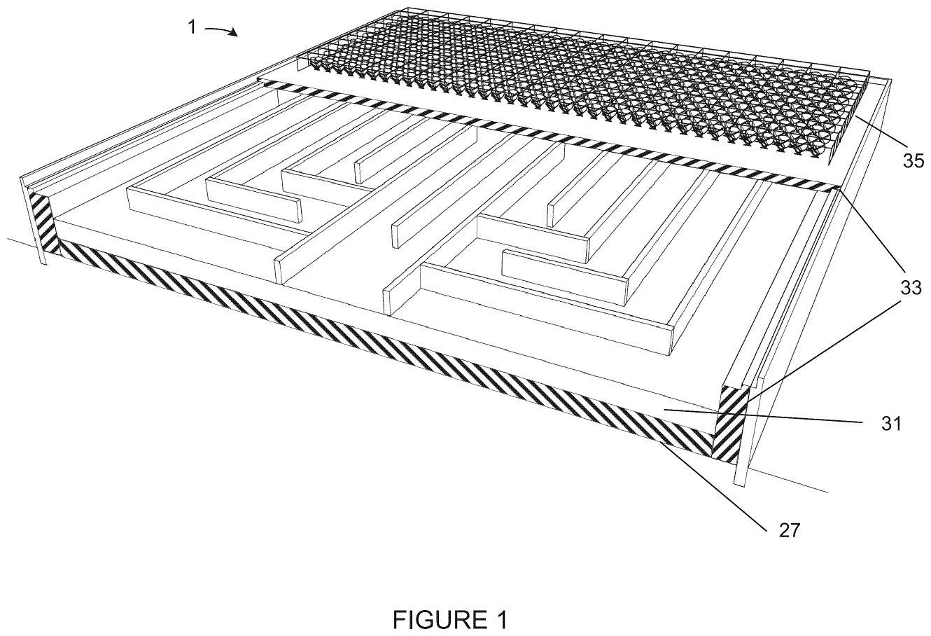

An exemplary embodiment of the present invention is shown in FIG. 1. Solar power system with energy storage 1 includes solar collectors 35, thermal storage material 31, and insulation 33 to help hold the heat in. A layer of insulation or insulating white sand 27 is also shown.

One can appreciate that if one were to flow air through the cavity 227 of the system in FIG. 26, the air will be cooler at the entrance to the cavity and hotter at the exit. As a result, the portion of the cavity near where the air enters will tend to become cooler faster, while the portion where the air exits will tend to stay warmer-a thermal gradient will tend to develop.

One can also appreciate that if the cavity is provided with substantially similar insulation throughout, the hotter, exit end will tend to suffer more thermal losses then the cool end.

The present disclosure discloses an arrangement of heat transfer fluid passages within the embodiment of FIG. 1 that can help to reduce thermal losses, by reducing the amount of exposed hot surface area.

For the purposes of brevity and clarity, the discussion that follows may refer to air and air passages, but it should be understood that any suitable heat transfer fluid, including but not limited to air, carbon dioxide, steam, or even non-gasses such as supercritical carbon dioxide or a liquid heat transfer fluid, may equally well be used.

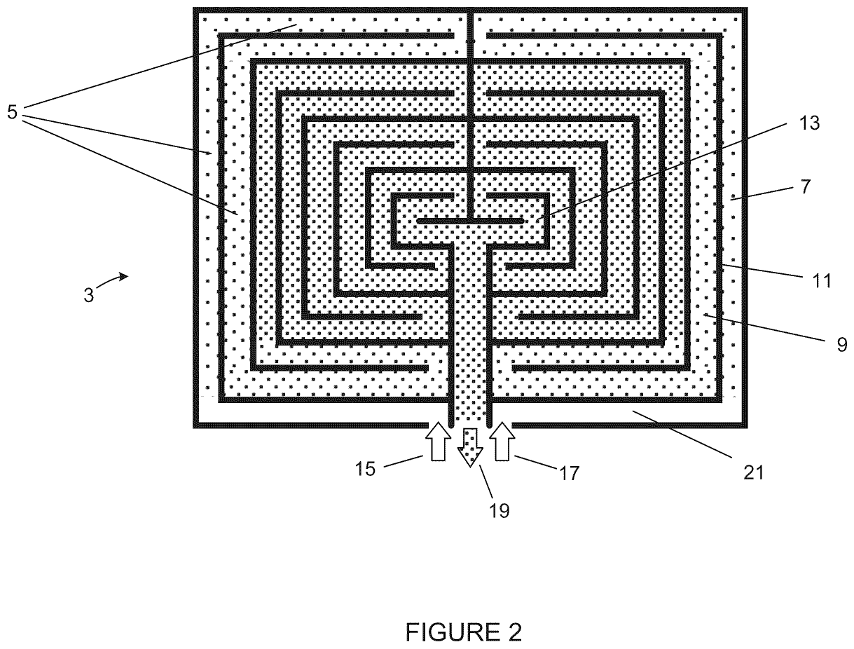

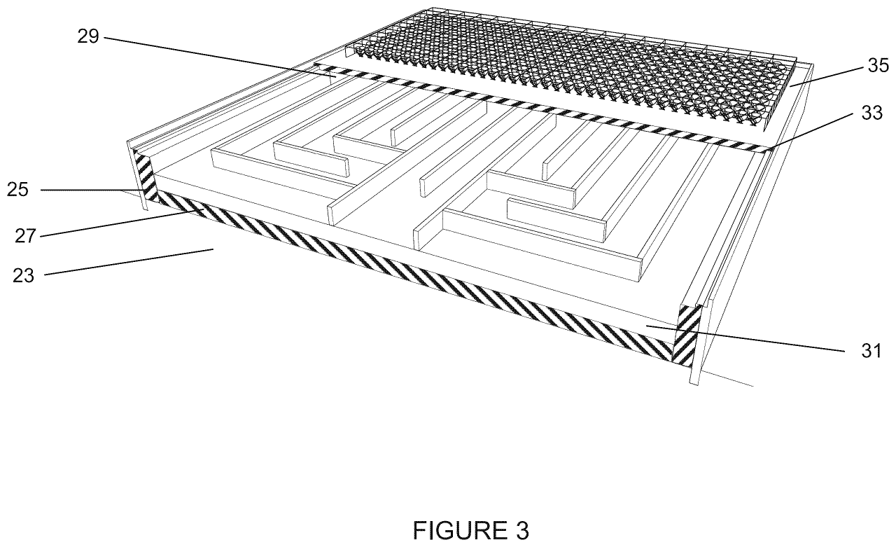

In one embodiment, this is accomplished by organizing the passages into a “maze” shape, as shown in FIG. 2. FIG. 3 is a 3-D cutaway view of such a maze. In FIG. 2, passages have been provided as a series of tunnel segments 5 that are arranged to form a maze 3.

Further, as suggested by the figure, the present invention teaches that portions of passages may share walls. For example, in maze 3, tunnel segments 7 and 9 share wall (or “partition”) 11.

In FIG. 2, arrows 15 and 17 represent the introduction of a heat transfer fluid into the maze of passages (e.g., the fluid flowing into an inlet end of each of two passages, which merge so that the two passages share a segment at an outlet end of both of the passages). Arrow 19 represents the path by which the heat transfer fluid exits the maze at the (shared) outlet end of each of the passages.

If the thermal storage medium within the passages has been heated, then the heat transfer fluid will be warmed as it transits the maze. The relative temperature of the fluid, and of the thermal storage medium within the maze, is indicated by the density of stippling in FIG. 2. Tunnel segment 21 is shown as cooler than tunnel segment 7. Tunnel segment 9 is warmer than 7, and tunnel segment 13 is the hottest, and the exit fluid flow 19 is very hot compared to the entry fluid flows 15 and 17. Generally, points near the center of the maze 3 are hotter than points near the periphery of the maze 3. As such, a central point chosen at or near the center of the maze 3 may be hotter than a peripheral point chosen at or near an exterior surface of the maze 3. The peripheral point may be chosen to be at a first distance from an exterior surface of the system, and the central point may be chosen to be at a second distance from the exterior surface of the system, the second distance being greater than the first distance. As used herein, the distance, of a point, “from an exterior surface of the system” means the shortest distance between the point and any point on the exterior surface of the system. As illustrated in FIG. 2, when a central point and a peripheral point are chosen in this manner, the central point may be closer to the outlet end of the passage than to the inlet end of the passage, as measured along the passage, i.e., a distance, along the passage, from the central point to the inlet end may be greater than a distance, along the passage, from the central point to the outlet end. Moreover, the peripheral point may be closer to the inlet end of the passage than to the outlet end of the passage, i.e., a distance, along the passage, from the peripheral point to the inlet end may be less than a distance, along the passage, from the peripheral point to the outlet end.

Features illustrated in the figure include: 1) a solar thermal collection and storage system may provide a two-dimensional passage structure; 2) portions of passages within the array may share walls; 3) heat transfer fluid may tend to enter the array via passages at the periphery of the array, and tend to exit via passages in the interior of the array.

These features together will tend to help to create a thermal gradient in the system, with the interior being hottest and the periphery being coolest. It can be appreciated that this sort of arrangement may help to minimize thermal losses—for the hottest interior passages, heat will largely tend to be lost only through the roof and floor, with only minimal losses through the sidewalls. Heat that is lost through the sidewalls isn't truly lost; it simply leaks into a neighboring passage.

One can further appreciate that this may reduce the need to heavily insulate the walls between adjacent passages, helping to reduce cost.

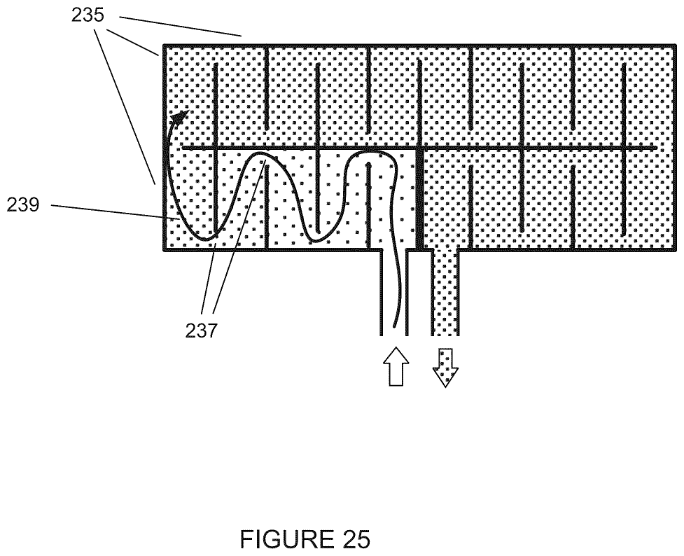

FIG. 25 presents another embodiment just by way of example. FIG. 25 shows an array of solar thermal containers with interior passages arranged in more of a “linear maze”. Such an embodiment may experience more heat losses than an embodiment like FIG. 2, but may nonetheless be useful, as it may be more compact, portable, and/or modular than the FIG. 2 embodiment. In FIG. 25, two rows of containers 235 are placed side by side, with ports 237 in the shared walls, effectively forming one long passage, through which heat transfer fluid flows as shown by arrow 239. The shared walls will tend to help to mitigate heat losses.

Such a system helps to reduce heat losses in two of the three dimensions, but losses through the roof and floor of the system are not appreciably mitigated by such a system. This leads to motivation for additional embodiments, which we shall now describe.

Referring to FIG. 26, the “thermal stack” of the system has a 1-dimensional character—from top to bottom it has a cover, a pair of insulation layers 225, a cavity 227, and thermal storage medium 220. Concentrated sunlight exits into cavity 227.

The embodiment of FIG. 3 includes an analogous cavity or gap as well, indicated by reference symbol 29. As shown in FIG. 3, walls have been provided within the cavity to structure the space into channels or passages.

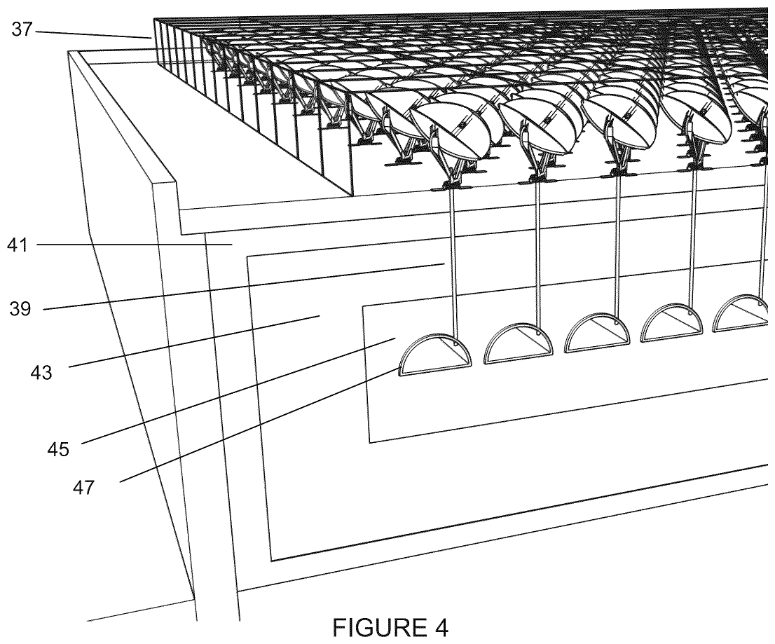

The present disclosure teaches embedding heat transfer fluid passages within the solar thermal energy storage medium, in some embodiments. In one embodiment, this comprises a conduit buried within the system's thermal storage material, as shown in FIG. 4.

In FIG. 4, collectors 37 collect concentrated solar radiation and couple it into light transfer conduits 39. As in FIG. 3, the light transfer conduits transit an insulation layer 41, but in this embodiment, they further transit an enclosing and insulative white sand layer 43 and also a portion of the thermal storage medium 45, exiting into a heat transfer conduit 47, shown as hemispherical in shape in the figure. The solar energy tends to be absorbed as heat by the conduit and conductively coupled into the storage medium 45.

Numerous related embodiments are possible. The heat transfer conduit may be any useful shape. Any useful set of layers may be provided—while white sand, black sand, and insulation form an exemplary layer stack, any useful stack may be used. In the figure, the layer stack is shown as substantially rectangular and enclosing the entire set of conduits, but it may be rectangular, elliptical, or any useful shape, and additional layers of the stack such as insulation may be placed in between the conduits, and heat transfer conduits may be arranged into passages, helping to implement thermal management schemes such as those illustrated in FIG. 2.

In FIG. 4, light transfer conduit 39 is shown exiting into the right side of hemispherical heat transfer conduit 47. In this embodiment, alternate rows of reflectors 37 exit into either the left or right side of the conduit, but any suitable exit locations may be used.

The embodiment shown includes no material in the heat transfer conduit other than the heat transfer fluid, helping to mitigate against contamination of the fluid. However, any useful arrangement may be used, and embodiments may include a thermal storage material, white sand, insulation, or any desired materials within the heat transfer conduit as well.

While FIG. 4 shows no gap regions (like gap 29 of FIG. 3) other than that within the heat transfer conduit, other gap regions or cavities may be included if desired. In some embodiments, such cavities may help mitigate the effects of thermal expansion by providing room for materials to expand.

One issue to address with a system using such a maze is what to do once the system becomes fully charged with heat, or even partially charged. Interior passages will tend to be hotter than peripheral passages, and over a period of time-hours or days or even weeks—the ongoing collection of solar energy may heat the interior passages to their maximum allowed temperature.

At that point, any further solar energy collection could conceivably damage the system. One way to deal with this is to simply cease collecting solar energy, disabling the solar collectors that are above the hottest passages. However, the disabling of otherwise operational solar collectors would be a regret that would tend to reduce the economic viability of such a system.

It would be desirable to instead redistribute heat within the passages, moving heat away from the maximum-temperature passages to cooler ones.

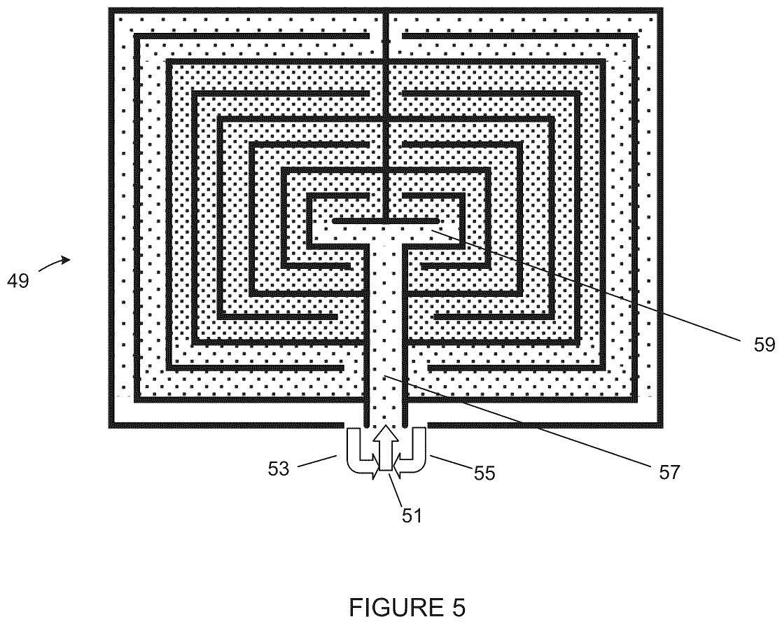

One embodiment, shown in FIG. 5, accomplishes this by flowing heat transfer fluid backwards through the system. In fully heated maze 49, fluid is fed backwards into the hot interior passages as indicated by arrow 51. In this embodiment, fluid flows backwards through the entire system, exiting at the entrance ports, but then is immediately recirculated, as indicated by arrows 53 and 55. This process may be used either when the sun is out and the unit is collecting energy, or when it is not collecting, such as at night, or both. In the figure, the backwards flow has started to cool tunnel segments 57 and 59 as indicated by the lower density stippling in these tunnel segments.

Some embodiments may flow fluid backwards through the entire system, others through just a portion of the system.

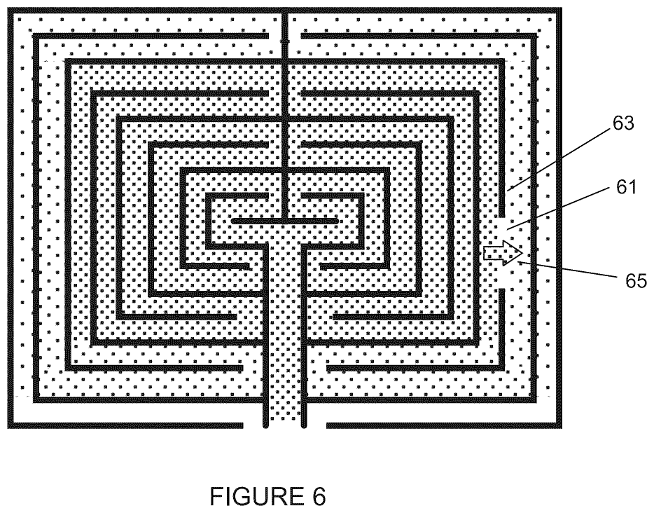

Other embodiments may open ports in the walls between passages, to allow heat to flow between them, as shown in FIG. 6. In FIG. 6, port 61 has been opened in wall 63, allowing heat to flow in the direction indicated by arrow 65. Heat transfer through the ports may either occur naturally, or via forced convection.

Some related art systems include concentrating solar collectors that deliver concentrated solar energy to a light transfer conduit using Fresnel lenses as concentrating elements, along with reflectors for beam folding.

The present disclosure includes embodiments that use one or more curved reflectors as an alternative to Fresnel lenses. A well-constructed reflector may have an optical efficiency advantage compared to a Fresnel lens.

Solar collectors for use with embodiments of the invention may include an azimuth axis articulation that spins the collector wholly or nearly wholly within a circle defined by its aperture, with little or no wobble or runout as it articulates, thus helping to permit collectors to be packed closely together, helping to maximize energy collection from a given surface area.

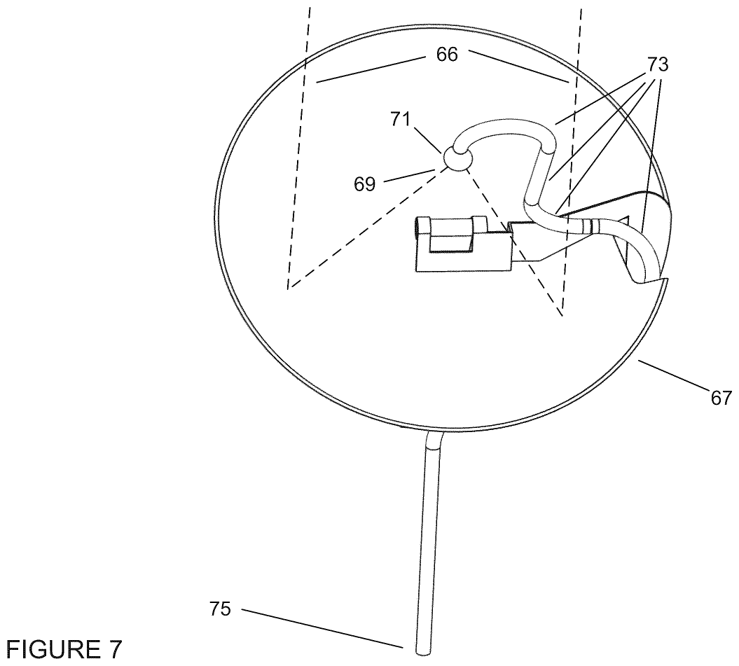

An example of an all-reflective embodiment is shown in FIG. 7. In this embodiment, a generally parabolic reflector (e.g., a reflector having a surface that is a portion of a paraboloid) is provided which reflects light to a focus above the reflector.

In this embodiment, rays 66 from the sun strike generally parabolic reflector 67 and are reflected to focal point 69, where an optional non-imaging concentrator optic 71 (such as a compound parabolic concentrator) further concentrates the beam, coupling it into light transfer conduit 73. Reflector 67 is aimed substantially directly at the sun during normal use, creating an intense focus at focal point 69.

In FIG. 7, light transfer conduit 73 is shown as a series of segments but may be fabricated either from individual segments or as one monolithic part. In some embodiments, light transfer conduit 73 uses the principle of total internal reflection, trapping the concentrated light inside and guiding it substantially losslessly to the exit port 75.

In the embodiment shown, the light transfer conduit is in fact fabricated from several segments, to allow the input to pivot while the output stays fixed in space. The gaps between the segments may lead to some loss of light, but that loss may be mitigated if the ends of the conduits are provided with a suitable anti-reflection coating.

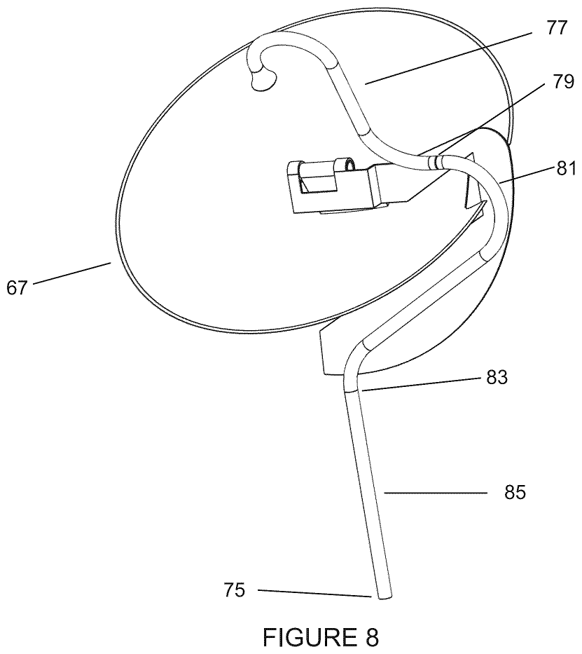

FIG. 8 provides a view that shows the entire light transfer conduit and the gap and pivots that allow it to move. In this embodiment segment 77 moves rigidly with the reflector 67 in both axes, pivoting at gap 79. Segment 81 then spins in azimuth about gap 83, which couples light into fixed segment 85, leading to exit port 75.

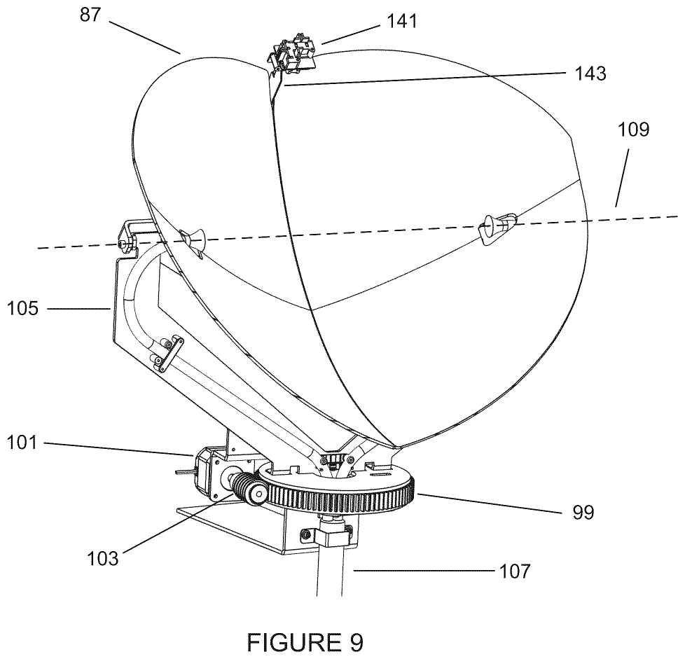

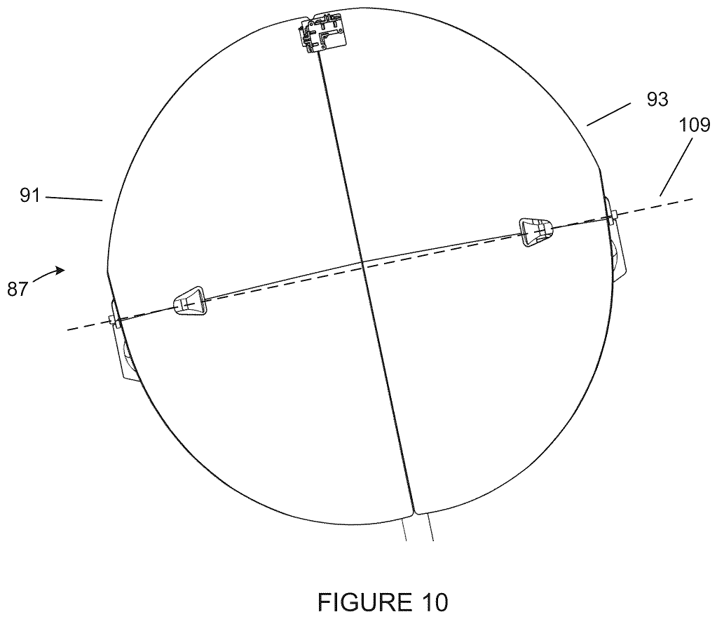

Another embodiment, shown in FIG. 9 and FIG. 10, provides an aperture including (e.g., consisting of) a pair of off-axis parabolic reflectors, each reflecting light to a focal region opposite the reflector, generally towards each other (e.g., each focusing received solar radiation generally toward the other reflector, e.g., focusing received solar radiation in a direction such that a 45-degree full-angle cone (or, in some embodiments, a cone with a full angle of between 15 degrees and 90 degrees) centered on the direction will include a portion of the other reflector). FIG. 9 is a perspective view of the collector embodiment, while FIG. 10 is a view from overhead, when the collector is pointed straight up.

As with the FIG. 7 embodiment, under normal operation this collector is aimed straight at the sun; the FIG. 10 view shows “what the sun sees” when the collector is well aimed. For the purposes of this discussion, we will differentiate between the “reflector assembly” 87, which is the entire collecting aperture as seen by the sun, and individual reflecting elements; in this embodiment, the reflector assembly comprises two individual reflecting elements-left-side reflector 91 and right-side reflector 93 each filling half the aperture.

The high-level features of the embodiment are shown in FIG. 9. It can be seen that the reflector assembly 87 resembles a clamshell, with left-side reflector 91 and right-side reflector 93 forming the two halves of the clamshell. The collector as a whole, including the azimuth drive motor 101, pivots in azimuth about a fixed azimuth gear 99. Azimuth drive motor 101 spins a worm 103 which drives against azimuth gear 99, spinning the entire assembly above.

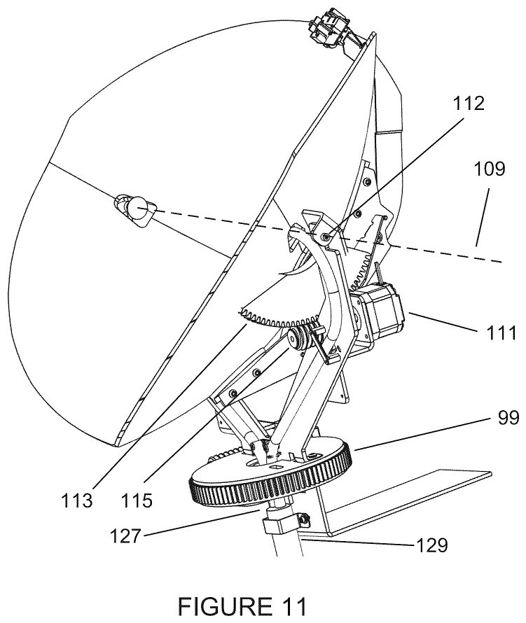

The assembly includes an azimuth yoke 105 that rotates the collector about the exit port 107, and an elevation axis 109 which allows the reflector to point to a desired sky location. The drive mechanism for elevation is not visible in FIG. 9 (in the figure, it is on the hidden side of the collector) but is shown in FIG. 11. It is mounted at the end of the azimuth yoke; motor 111 drives the elevation axis 109 through reduction gear 113 via worm 115 at pivot point 112.

Optically, the reflector comprises two individual reflective halves, each comprising an off-axis paraboloid and forming a distinct focus on the input aperture of a light transfer conduit. The reflectors in this embodiment are formed from injection-molded plastic. Glass, plastic, or metallic reflectors, or reflectors made from any suitable material, may be used.

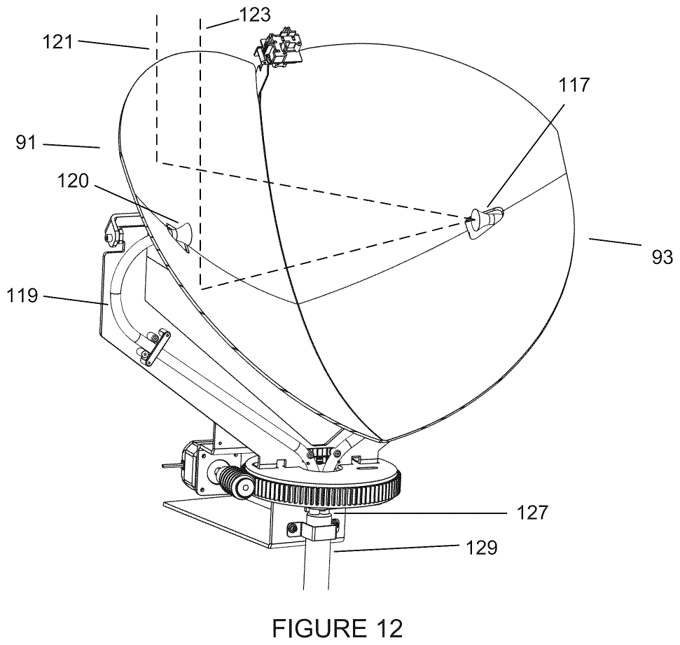

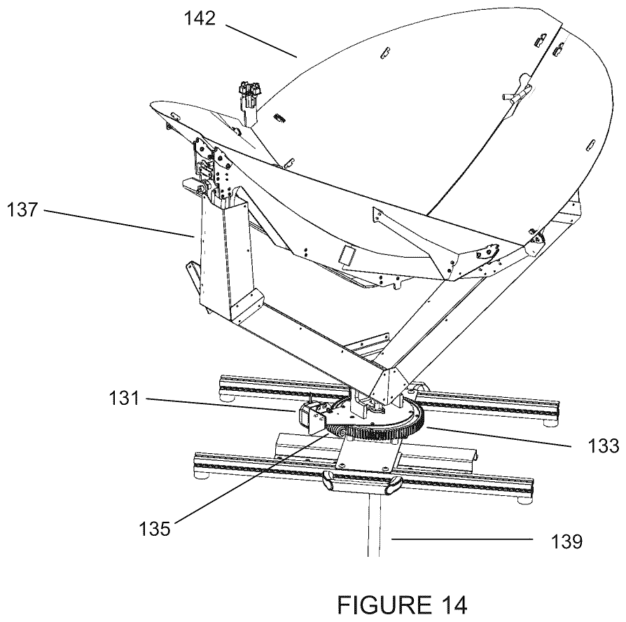

The embodiment includes two light transfer conduits, one for each of the two paraboloids. Referring to FIG. 12, reflector 91 forms a focus onto the entrance aperture of light transfer conduit 117, as indicated by exemplary sun rays 121 and 123. Likewise, reflector 93 forms a focus at the entrance aperture of light transfer conduit 119. In FIG. 12, light transfer conduit 119 appears to be segmented; this is just an artifact of the computer aided design (CAD) software used to render the design. In this embodiment, light transfer conduit 119 is a single monolithic curved glass rod that has been formed to the desired shape. Other embodiments may use a segmented light transfer conduit, however. Each sun ray (such as sun rays 121 and 123) may include a portion, or “reflected ray path” extending from the point of reflection to the entrance to the light transfer conduit that it illuminates. For each reflector (e.g., the two reflectors of FIG. 12, or the four reflectors of, e.g., FIGS. 14-19) one or more such reflected ray paths may extend substantially horizontally (e.g., within 10 degrees of horizontally) to an entrance to a light transfer conduit. As used herein, a direction is “substantially horizontal” if it is within 10 degrees of being horizontal.

In some embodiments, light transfer conduits 117 and 119 are uncoated fused quartz or fused silica rods. In other embodiments, they may include a “cladding” layer of a lower-index optical material. The light transfer conduits in one embodiment include a nanoporous glass coating manufactured by Swift Coat, Inc. of Phoenix, Arizona.

As shown in FIGS. 9, 10, and 11, the elevation axis of the collector passes substantially through the center of the input aperture of light transfer conduits 117 and 119, thus helping the focal points of reflectors 91 and 93 to stay centered on their respective input apertures as the collector articulates in elevation.

FIG. 12 also shows trumpet-shaped non-imaging concentrator element 120 at the input end of light transfer conduit 119. In this embodiment, non-imaging concentrator element 120 is composed of solid glass and is actually an integral part of the light transfer conduit. Other embodiments may use hollow reflective concentrators, or no concentrator at all, and element 120 may be integrated into light transfer conduit 119, or it may be a separate component. Non-imaging concentrator element 120 may provide additional optical concentration via the principles of non-imaging optics, helping to reduce the required precision of the collector mechanism and reflectors, by providing a larger target region for the focused beam.

As shown in FIG. 11, light transfer conduits 117 and 119 conduct concentrated sunlight from their inputs, through a hole in azimuth gear 99, to a small air gap 127, where they end. The two rods spin in azimuth along with the collector, above a fixed, larger-diameter, final shared light transfer conduit 129, which delivers the combined beam into the solar energy storage container.

In some embodiments, drive mechanisms from multiple collectors may be ganged together and be driven by a single motor and an appropriate gear train and/or linkage. For example, in one embodiment, the azimuth motor is a linear motor that drives a rack-and-pinion geartrain. The motor drives the rack gear forward and backward like a trombone, and the rack gear then drives azimuth pinion gears of multiple collectors, while each collector retains its own elevation motor. In another embodiment, one motor drives all four collectors' elevation gears. Schemes to share elevation drives are more complicated than azimuth but are possible. In some embodiments, drives are provided in which there are two motors, but they may not be strictly azimuth and elevation. By way of example, one motor may drive azimuth, while the other drives azimuth+elevation. The drive motions can be decomposed in software to produce any desired collector motion.

FIG. 9 also shows tracking sensor 141 mounted on arm 143. Tracking sensor 141 is mounted on the “upper lip” of the reflector to help it avoid being shadowed by neighboring collectors. That is, in this embodiment, sensor 141 is at the “back” of the mirror and generally moves upward from horizontal, while the “front” lip of the mirror moves from horizontal down towards the base of the unit.

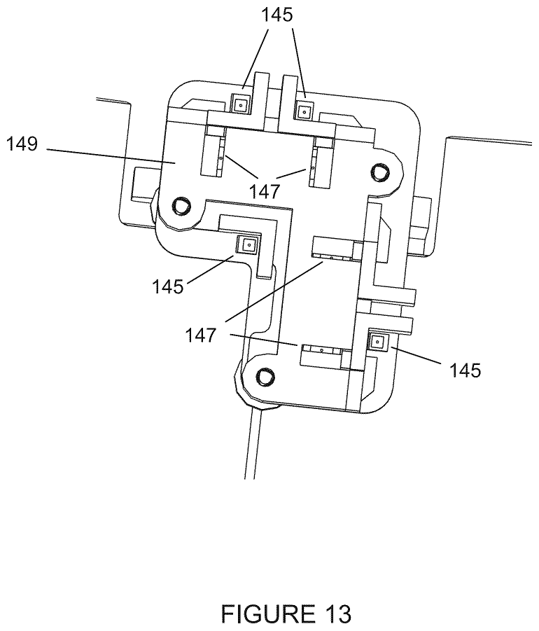

The tracking sensor itself uses an array of four wide-angle photodiodes and four narrow-angle photodiodes, following techniques similar to those taught in U.S. Pat. No. 8,697,983. The wide-angle photodiodes act as a quadrant sensor, while the narrow-angle photodiodes act as a pair of independent single-axis sensors. A close-up of the sensor is shown in FIG. 13. The wide-angle photodiodes are indicated with reference symbol 145, while the narrow-angle photodiodes are identified by reference symbol 147. Housing 149 provides blocking pillars and apertures as taught by 8,697,983.

Another embodiment of the invention is shown in FIG. 14. It shares many features in common with the embodiment of FIG. 9, including an azimuth motor 131, an azimuth gear 133, worm 135, and azimuth yoke 137, and final light transfer conduit 139. However, reflector assembly 142 differs from the FIG. 9 embodiment.

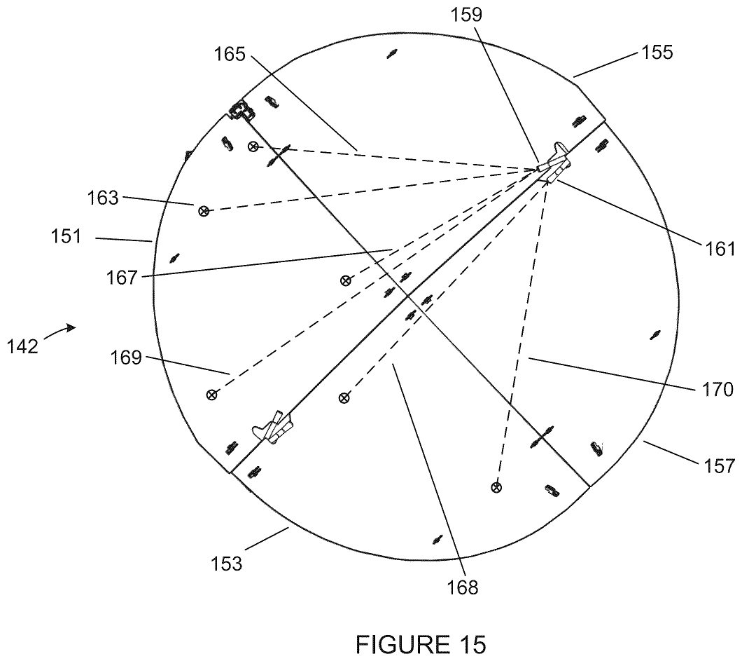

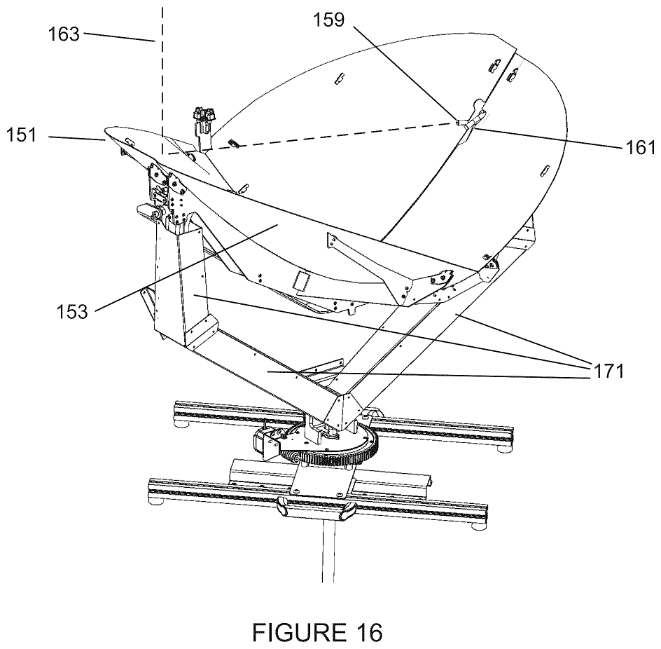

The overhead view of FIG. 15 helps to illustrate the difference. In this embodiment, the reflector comprises four individual reflective quadrants, each forming a distinct focus on the input aperture of a light transfer conduit. The embodiment includes four light transfer conduits, one for each quadrant. Referring also to FIG. 16, quadrant 151 forms a focus onto the entrance aperture of light transfer conduit 159, as indicated by exemplary sun rays 163, 165, 167, and 169. (FIG. 15 is from the point of view of the sun, so the rays are coming from the eye of the viewer of the figure, so the portion of the ray directed into the paper is indicated just by an X with a circle, as is often done in vector diagrams.) Likewise, quadrant 153 forms a focus at the entrance aperture of light transfer conduit 161, as indicated by exemplary rays 168 and 170. The tip of light transfer conduit 159 is aimed substantially at the optical center of reflector quadrant 151.

Referring to FIG. 16, most of the length of light transfer conduits 159 and 161, and the corresponding pair of conduits on the other side of the collector, are not visible because they are hidden beneath azimuth yoke covers 171. Azimuth yoke covers 171 help to keep dust and other contaminants from settling on the surface of the light transfer conduits, which in many embodiments are uncoated fused quartz or fused silica rods. The embodiment of FIG. 16 and other embodiments disclosed herein may be capable of articulating over a large angle (unconstrained by mechanical stops) in azimuth (e.g., over an angle of at least 90 degrees or over a range of angles spanning between 30 degrees and 180 degrees, or even continuous rotation through a full 360 degrees and beyond) and may also be capable of articulating in elevation over a range of angles spanning between 10 degrees and 95 degrees (e.g., over a range of angles spanning at least 35 degrees, or over a range of angles spanning at least 60 degrees). These embodiments may further have the characteristic that multiple concentrating solar energy collectors may be placed close to each other without their colliding with each other as they articulate, e.g., even if one or more of the articulation mechanisms have failed so that adjacent collectors may be pointed in different directions. For example, the concentrating solar energy collector may fit entirely within a fixed volume having the shape of a vertical cylinder (e.g., a cylinder having an axis parallel to and near the axis of rotation of the azimuth stage), over the entire range of articulation angles for both azimuth and elevation, or at least over a subset of these angles (e.g., over a range of azimuth angles spanning at least 90 degrees and a range of elevation angles spanning at least 35 degrees). The diameter of such a cylinder may be at least as great as the diameter of the reflective surface as seen from the direction of the received solar radiation (e.g., the roughly circular area covered by the reflectors illustrated in FIG. 15, which, as explained above, is a view taken from the point of view of the sun). In some embodiments, the fixed vertical cylindrical volume has a diameter that is e.g., between 1.05 times as great as and 2.0 times as great as, or less than 1.5 times as great as, the diameter of the reflective surface as seen from the direction of the received solar radiation.

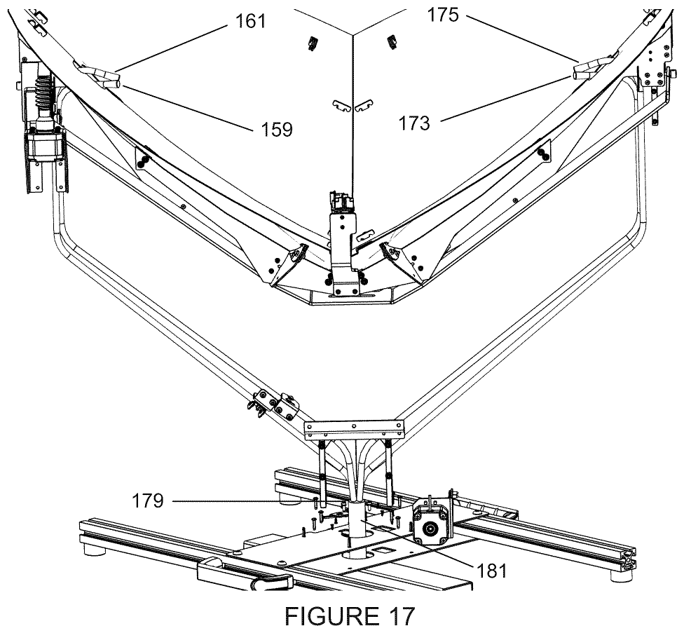

FIG. 17 shows the collector with the covers and frame removed, exposing the four light transfer conduits 159, 161, 173, and 175. In FIG. 17, the azimuth gear and associated housings have also been removed so that we can see inside to see the ends of the four light transfer conduits.

In this embodiment, there are two types of light transfer conduits, an “upper quadrant” conduit and a “lower quadrant” conduit. The two upper quadrant conduits 159 and 173 are identical, and lower quadrant conduits 175 and 161 are identical.

As shown in FIGS. 14-17, the input ends of the light transfer conduits have a slight conical shape, providing additional optical concentration via the principles of non-imaging optics, similar in function to concentrating element 120 of FIG. 12, but simpler.

All four light transfer conduits conduct concentrated sunlight from their inputs to the exit region 179, where they end, at a small air gap. The four rods spin in azimuth along with the collector, above a fixed, larger-diameter, final shared light transfer conduit 181, which delivers the aggregate beam into the solar energy storage container.

Compared to the embodiment of FIG. 9, the light transfer conduits of the FIG. 14 embodiment are designed to each capture light from an angular area that is approximately half as large, concentrating light emanating from a single reflector quadrant rather than from two quadrants. This aspect of the embodiment can help enable the non-imaging element to be simpler and smaller, and also can help enable the light transfer conduit to have a smaller diameter, helping to reduce cost.

The embodiment shown in FIGS. 14 through 17 is approximately 33 inches in diameter; in other embodiments, the diameter may be between 8 inches and 10 feet.

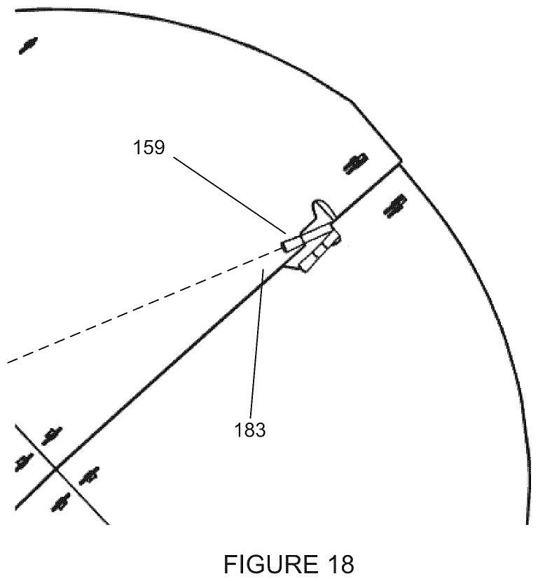

The illustrated embodiment includes a slight angle offset to each per-quadrant light transfer conduit, helping to allow it to be designed for a smaller overall angle of acceptance. FIG. 18 shows this angle 183 for light transfer conduit 159. As suggested by the figure, the tip is aimed generally at the optical center of the quadrant 151 reflector. In this embodiment, an angle offset is provided in both the lateral and vertical directions—in addition to aiming slightly sideways, the tip also aims slightly downward.

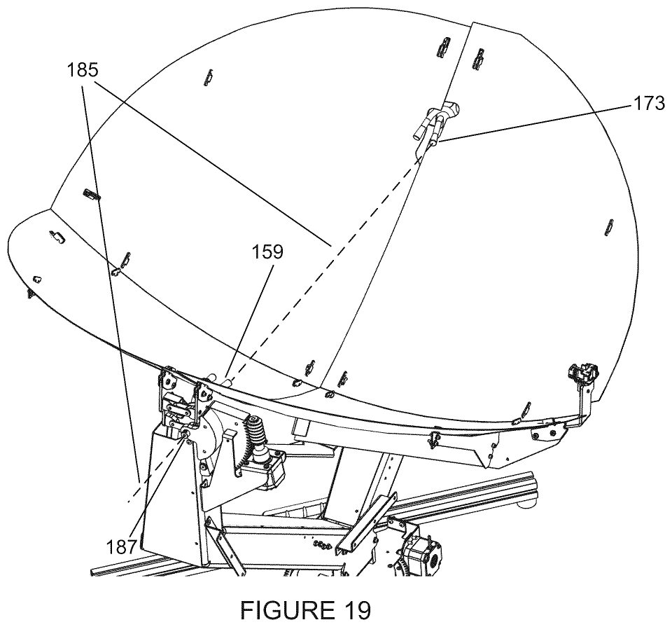

As shown in FIG. 19, The elevation axis for this embodiment is placed in a slightly different location from the FIG. 9 embodiment. The elevation axis 185 passes through elevation axis bearing 187 and then through the centers of the input faces of the upper quadrant reflectors' light transfer conduits 159 and 173. Thus, as the upper quadrant reflectors pivot in elevation about this axis, their focal points will each tend to remain substantially on the input face of the corresponding light transfer conduit.

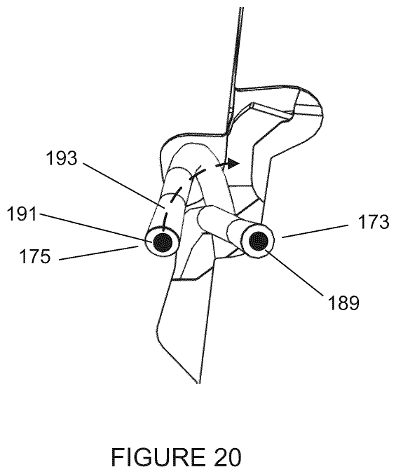

The situation is different for the lower quadrant reflectors 153 and 157. In this embodiment, the lower quadrant reflectors are not rigidly connected to the upper quadrant reflectors. If they were rigidly connected, the focus of these reflectors would not remain stationary as the collector pivots in elevation, and light would tend to be lost. This is shown conceptually in FIG. 20.

FIG. 20 is a close-up of the input faces of light transfer conduits 173 and 175, in a scenario where the collector is aimed nearly straight overhead. A focal spot 189 from upper reflector quadrant 155 is shown on the face of light transfer conduit 173, and a focal spot 191 from lower reflector quadrant 157 is shown on the face of light transfer conduit 175. Such a scenario presupposes that the collector quadrants have been installed and aligned to produce the spots at these locations.

Considering what happens when the collector rotates in elevation, the upper quadrant focal spot 189 will tend to remain stationary, since the elevation axis passes directly through the face of light transfer conduit 173. If the lower quadrant reflector 157 were rigidly connected to upper quadrant reflector 155, the effect would be for focal spot 191 to orbit focal spot 189 as the unit moves in elevation, as indicated by arrow 193.

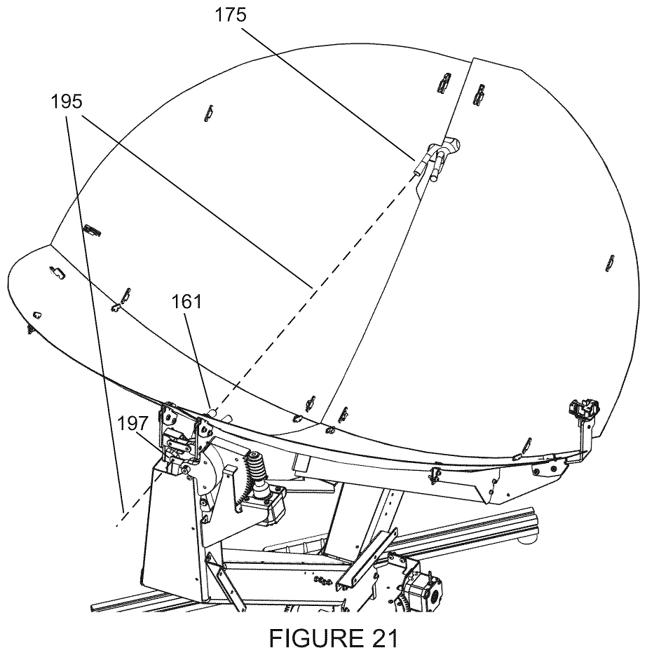

To help minimize this effect, the embodiment provides a four-bar parallelogram linkage as shown in FIGS. 21, 22, and 23. First, FIG. 21 shows the pivot axis for the lower quadrant reflectors. Just as with the upper quadrant reflectors, they rotate about a line 195 connecting the input faces of the corresponding light transfer conduits 161 and 175. This line passes through lower quadrant axle bearing 197.

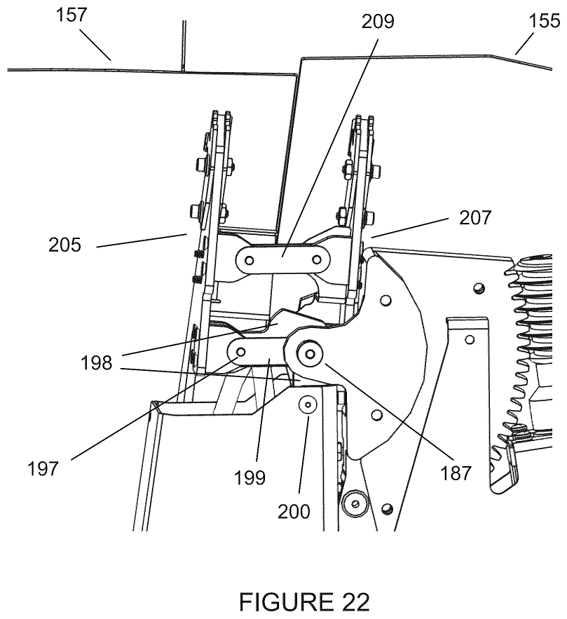

FIG. 22 is a view of the elevation axis mechanism at one end of the azimuth yoke 137. In this embodiment, the same linkage appears on both ends of the elevation axis but some embodiments may only provide the linkage at one end.

In FIG. 22, lower quadrant reflector 157 is at left and upper quadrant reflector 155 is at right. Upper quadrant reflector 155 pivots about elevation axis bearing 187, while lower quadrant reflector 157 pivots about lower reflector pivot axis bearing 197.

In this embodiment, bearings 187 and 197 are fixed relative to the azimuth yoke. Bar 199 connecting them is thus also fixed and rigid relative to the azimuth yoke, and forms the fixed base of the parallelogram. The sides of the parallelogram are formed by support strut 205 of lower quadrant reflector 157 and support strut 207 of upper quadrant reflector 155. Link arm 209 is the upper bar of the parallelogram and couples the force that causes motion of the lower quadrant reflector. In addition to bar 199, L-shaped structural member 198 also is rigid and provides mechanical support for lower quadrant reflector 157. In effect, structural member 198 and bar 199 are in parallel mechanically. In this embodiment, the two parts have slightly different design intents. Bar 199 is manufactured identically to bar 209, and thus provides precise parallelogram geometry for the linkage. Structural member 198 fits more loosely and is intended to provide mechanical support. Member 198 is partially obscured in the figure; it has an inverted “L” shape and is fixed to the azimuth yoke by fastener 200 and by additional fasteners that are off the bottom of the page.

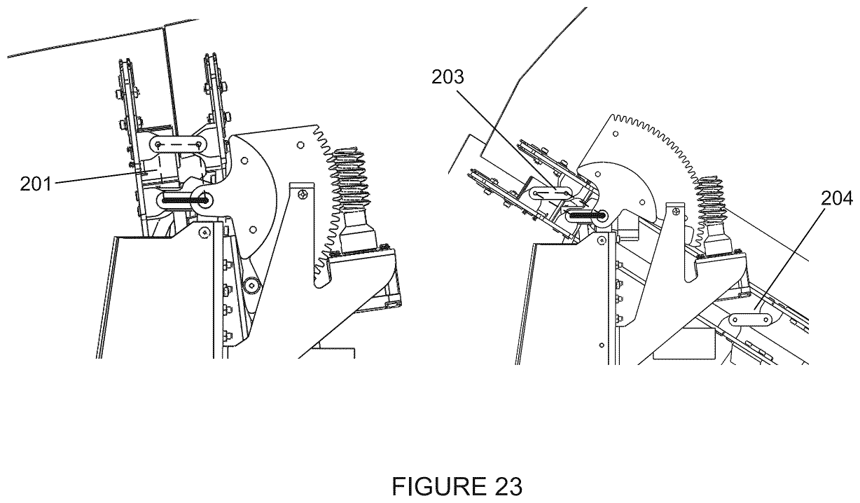

To illustrate schematically, FIG. 23 shows the mechanism in two angles of articulation. A parallelogram shape 201 is shown overlaid on the linkage on the left side of FIG. 23. The fixed base 199 is shown in bold. At the right side of the figure, skewed parallelogram 203 shows how the mechanism articulates, with base bar 199 remaining fixed.

Some embodiments include redundant linkage arms. FIG. 23 also shows redundant linkage arm 204. This linkage arm tends to follow the same parallelogram motion as link arm 209, thus helping to provide additional stiffness to the coupling of the two reflectors.

Due to the parallelogram motion, the two reflectors tend to naturally maintain parallel aiming. In some embodiments, the side arms of the parallelogram are each aligned with the line of sight of their respective reflectors, and these arms are naturally constrained to be substantially parallel. Thus, the direction of aim of the upper and lower reflectors is constrained to always remain substantially the same.

As the collector rotates in elevation, reflector 157 will tend to move slightly closer to and further from reflector 155 and may overlap slightly.

Thus we see that the embodiments of FIG. 7 through FIG. 23 all comprise one or more light transfer conduits that pivot with the collector in azimuth, and also a gap (e.g. 127, 179) to allow the pivoting to occur. There are variations of the embodiments of FIGS. 7-23 which include no gap, however.

One such embodiment is a variant of the embodiment of FIG. 17. In this embodiment, the final shared light transfer conduit 181 is rigidly fused to light transfer conduits 159, 161, 173, and 175, and also rotates with the azimuth axis, with this rotation extending all the way down into the thermal storage vessel. This requires careful management of the insulation seals going into the vessel, but represents a viable embodiment that would eliminate optical losses at the air gap 179.

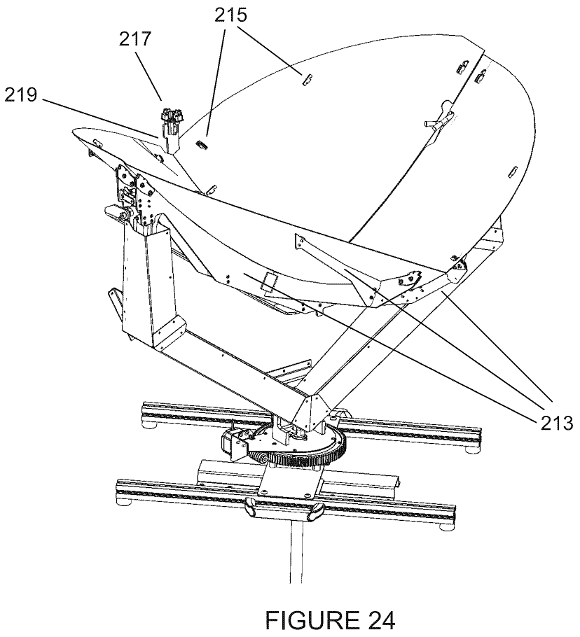

FIG. 24 shows a set of support ribs which are used to help support and shape the reflector in the embodiment of FIG. 17. In the illustrated embodiment, the reflector is comprised of Alanod reflective aluminum, formed to the desired shape via a stamping process. Support ribs 213 (including those hidden from view) help to provide support for the mirror against the force of gravity, as well as helping to define the static shape.

The support ribs include tabs 215 which grip the reflector quadrants through slots in the reflectors, helping to constrain the reflectors to the desired shape.

The figure also shows tracking detector 217 on its support arm 219, mounted at the upper lip of the collector.

Any numerical range recited herein is intended to include all sub-ranges of the same numerical precision subsumed within the recited range. For example, a range of “1.0 to 10.0” (or “between 1.0 and 10.0”) is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. As used herein, “types” of systems refers to “kinds” of systems.

All patents, patent applications, and publications cited herein are incorporated by reference as if individually incorporated. The foregoing detailed description has been given for clarity of understanding only. No unnecessary limitations are to be understood therefrom. The invention is not limited to the exact details shown and described, for variations obvious to one skilled in the art will be included within the invention defined by the claims, and equivalents thereof.

What is claimed is:

1. A system, comprising:
a concentrating solar thermal power collection and storage system, the concentrating solar thermal power collection and storage system comprising:
an insulated barrier surrounding an insulated region;
a stationary thermal energy storage material within the insulated region; and
a passage for a heat transfer fluid,
the passage including an inlet end and an outlet end and passing through:
a peripheral point, at a first distance from an exterior surface of the system, and
a central point, at a second distance from the exterior surface of the system,
the second distance being greater than the first distance, and
a distance, along the passage, from the central point to the inlet end being greater than a distance, along the passage, from the central point to the outlet end.

2. The system of claim 1, wherein a distance, along the passage, from the peripheral point to the inlet end is less than a distance, along the passage, from the peripheral point to the outlet end.

3. The system of claim 1, wherein a portion of the passage is embedded within the stationary thermal energy storage material.

4. The system of claim 1, further comprising:
a concentrating solar energy collector; and
a light transfer conduit for transferring received energy through the insulated barrier from outside the insulated region to inside the insulated region.

5. The system of claim 4, wherein the light transfer conduit extends into the passage.

6. The system of claim 1, comprising:
a partition separating a first portion of the passage from a second portion of the passage; and
a port in the partition, the port, when opened, permitting heat transfer fluid to flow through the port from the first portion of the passage into the second portion of the passage.

7. A method for operating the system of claim 1, the method comprising:
causing, during a first time interval, heat transfer fluid to flow into the inlet end of the passage, and
causing, during a second time interval, heat transfer fluid to flow into the outlet end of the passage.

8. A system, comprising:
a concentrating solar energy collector, the concentrating solar energy collector comprising:
a first reflector;
a second reflector;
a first light transfer conduit; and
a second light transfer conduit,
the first reflector being configured to focus received solar radiation onto an entrance to the first light transfer conduit,
a reflected ray path from the first reflector extending substantially horizontally to the entrance to the first light transfer conduit.

9. The system of claim 8, wherein:
the second reflector is configured to focus received solar radiation onto an entrance to the second light transfer conduit,
a reflected ray path from the second reflector extending substantially horizontally to the entrance to the second light transfer conduit.

10. The system of claim 8, wherein the first reflector is configured to rotate about a first elevation axis, the first elevation axis passing through the entrance to the first light transfer conduit.

11. The system of claim 8, further comprising:
a third light transfer conduit;
a third reflector, configured to focus received solar radiation onto an entrance to the third light transfer conduit;
a fourth light transfer conduit; and
a fourth reflector, configured to focus received solar radiation onto an entrance to the fourth light transfer conduit,
wherein:
a reflected ray path from the third reflector extends substantially horizontally to the entrance to the third light transfer conduit, and
a reflected ray path from the fourth reflector extends substantially horizontally to the entrance to the fourth light transfer conduit.

12. The system of claim 11, wherein the third reflector is configured to rotate about a second elevation axis, the second elevation axis passing through the entrance to the third light transfer conduit.

13. The system of claim 12, wherein:
the fourth reflector is configured to rotate about the second elevation axis, and
the second elevation axis passes through the entrance to the fourth light transfer conduit.

14. The system of claim 13, wherein the third reflector is connected to the first reflector by a link, the link being one of four links forming a parallelogram four-bar linkage.

15. The system of claim 8, wherein the entrance to the first light transfer conduit is an entrance to a non-imaging concentrator optic.

16. The system of claim 8, wherein:
the first light transfer conduit includes a curved portion, and
the second light transfer conduit includes a curved portion.

17. The system of claim 8, wherein:
the first light transfer conduit conducts light to a fixed final shared light transfer conduit, and
the second light transfer conduit conducts light to the fixed final shared light transfer conduit.

18. The system of claim 8, wherein the concentrating solar energy collector is configured:
to articulate in azimuth through a range of azimuth angles spanning at least 90 degrees,
to articulate in elevation through a first range of elevation angles spanning at least 60 degrees,
to fit within a fixed vertical cylindrical volume, for all azimuth angles in the range of azimuth angles and all elevation angles in the range of elevation angles, the fixed cylindrical volume having a diameter less than 1.5 times a diameter of the reflective surface as seen from the direction of the received solar radiation.

19. The system of claim 8, wherein:
the first reflector is an off-axis parabolic reflector focusing received solar radiation generally toward the second reflector, and
the second reflector is an off-axis parabolic reflector focusing received solar radiation generally toward the first reflector.
